(19) United States
(12) Patent Application Publication
(10) Pub. No.: US 2009/0292566 A1
(43) Pub. Date: Nov. 26, 2009

(54) Yield Management of Configurable Restaurants

(76) Inventor: John Meyer Bossert, Boston, MA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 12/469,260

(22) Filed: May 20, 2009

Related U.S. Application Data
(60) Provisional application No. 61/128,223, filed on May 20, 2008.

(51) Int. Cl. G06Q 50/00; G06Q 10/00

(52) U.S. Cl. 705/5

(57) ABSTRACT

Program products, apparatuses, and methods that manage a reservation yield in a manner accounting for and utilizing the option to dynamically reconfigure resources are disclosed. Application may lead to a more efficient use of the resources and an increase in revenue. For example, the reservation yield of a restaurant and of hotel or lodging establishments may be managed in a manner that accounts for the potential to reconfigure table layout and room layout, respectively.

### CROSS-REFERENCE TO RELATED APPLICATIONS

This application claims the benefit of the following commonly-owned U.S. Provisional Patent Application, which is incorporated herein by reference in its entirety: App. No. 61/128,223 filed on May 20, 2008 and entitled “Yield Management of Configurable Restaurants.”

### BACKGROUND OF THE INVENTION

1. Field of the Invention

This invention relates generally to reservations and reservation systems, and more specifically to restaurant reservations and reservation systems employing configuration of a restaurant's physical space to manage yield. The invention also relates to yield management techniques and systems.

2. Description of Related Art

Yield or revenue management practices are designed to increase the revenue derived from a set of perishable resources, often by selectively accepting resource requests. Typically, as the yield improves so does revenue. Airline ticket sales are a notable application of yield management. Airline seats are perishable resources in the sense that all empty seat cannot be sold after flight departure, and airline yield management is typically effected through the dynamic modification of offered fare classes familiar to many travelers. Though some yield management concepts can be practiced informally, application typically involves computer-implemented algorithms to estimate whether the relatively certain benefit of accepting a pending resource request compensates for ceding the uncertain future value of the requested resources.

Researchers and practitioners have extended yield management from air travel to other industries including hotels and lodging, cruise ships, car rentals, and cargo shipping, as well as restaurants. Moreover, revenue management techniques have been developed for “flexible products”. A flexible product is purchased without full specification; instead, after purchase, the seller supplies one alternative from a menu of specific products. Perhaps the most notable example is the “airline-specified flight ticket”. Under such all arrangement, a traveler purchases a ticket satisfying certain parameters, but exact flights are assigned only after purchase. The tour operator industry also offers flexible products, such as a vacation package for which certain details, perhaps the departure flight or hotel, are specified after purchase.

With respect to restaurants, some efforts have been focused more directly on yield management while other efforts have been focused on the configuration of restaurant tables.

A need therefore exists in the art for an improved manner of handling reservation requests for restaurant capacity and similar resources that more fully utilizes resource configurability to increase yield or revenue.

### SUMMARY OF THE INVENTION

In embodiments, the present invention may provide a method and system for receiving a reservation request to be seated in a restaurant, wherein the request is associated with a requested seating constraint. The reservation request may be transferred to a restaurant capacity calculation module, wherein the restaurant capacity calculation module is further associated with a data facility including data relating to restaurant capacity and configuration. A calculation may be performed within a capacity calculation module to determine if sufficient capacity exists at the restaurant to accommodate the reservation request. A statistical calculation may be performed within a yield management calculation module, wherein the statistical calculation includes analysis of alternate physical arrangements of the restaurant's physical infrastructure to select a target physical arrangement in order to optimize a yield criterion. Finally, a target physical arrangement may be selected and a reservation recorded to accommodate the reservation request within the target physical arrangement.

In embodiments, the performance of the statistical calculation within the yield management calculation module may be used to determine if sufficient capacity exists at the restaurant to accommodate the reservation request includes a calculation to accommodate a prior reservation, in combination with the reservation, within the target physical arrangement. A physical arrangement of the restaurant may be transformed to the target physical arrangement.

In embodiments, a reservation request to be seated in a restaurant may be received, wherein the request is associated with a requested seating constraint. The reservation request may be transferred to a restaurant capacity calculation module, wherein the restaurant capacity calculation module is further associated with a data facility including data relating to restaurant capacity and configuration. A calculation may be performed within a capacity calculation module to determine if sufficient capacity exists at the restaurant to accommodate the reservation request. A statistical calculation may be performed within a yield management calculation module, wherein the statistical calculation includes analysis of alternate physical arrangements of the restaurant's physical infrastructure to select a set of possible target physical arrangements. Finally, a reservation may be recorded to accommodate the reservation request within one or more members of the set of target physical arrangements.

In embodiments, a seating constraint may be a seating date, a seating time, a requested number of persons to be seated at the restaurant, a requested location in the restaurant, such as a specific table, a requested seating date and time combination, a combination of a requested seating date, seating time, and a requested number of persons to be seated, a combination of a requested seating date, seating time, a requested number of persons to be seated, and a requested location in a restaurant, or some other type of seating constraint.

In embodiments, the data relating to restaurant capacity and configuration may include the total number of tables at a restaurant, the total number of tables currently available at the restaurant that have not been reserved, the total number of seats at the restaurant, the total number of seats at the restaurant that have not been reserved, the table types that are present at the restaurant, the number of seats at each table type, the prior reservations made at a table, a revenue metric associated with a prior customer transaction conducted at a table, or some other type of data relating to restaurant capacity and configuration. In embodiments, a prior customer transaction may include a total amount spent during one restaurant seating, a total amount spent on beverages during one restaurant seating, a total tip amount spent during one restaurant seating, some cumulative amount spent, or some other type of revenue metric relating to customer transactions.

In embodiments, a yield criterion may be a revenue metric. A revenue metric may be the revenue associated with a table per a single customer seating, a measure of the revenue associated with a table per a single day, the revenue associated with a table per a single week, or some other type of revenue metric. In embodiments, a yield criterion may be a measure of the percentage of full capacity seating achieved.

In embodiments, a yield criterion may be optimized based at least in part on controlling the availability of table reservations according to a diner class. A diner class may be based at least in part on a diner's requested seating time, a requested number of persons to be seated, or a status past on a past behavior, such as the status of being a breakfast patron, lunch patron, dinner patron, bar patron, a business dinner patron, a family diner, or some other type of diner classification.

In embodiments, a yield management calculation module may calculate a statistical forecast of reservation demand. A target physical arrangement may be based at least in part on a statistical forecast of reservation demand.

In embodiments, a target physical arrangement, based at least in part on a table assignment and a table configuration, may remain flexible until the end of a reservation process. A table layout may be determined at the end of the reservation process and a specific table may be assigned to each accepted reservation request.

In embodiments, the capacity calculation module may employ dynamic programming techniques.

In embodiments, the yield management calculation module may employ dynamic programming techniques.

In embodiments, the present invention provides program products, apparatuses, and methods that manage a reservation yield in a manner accounting for and utilizing the option to dynamically reconfigure resources, potentially leading to a more efficient use of the resources and an increase in revenue.

Consistent with the principles of the present invention, some embodiments may manage a reservation yield of a restaurant in a manner that accounts for and utilizes the option to dynamically reconfigure the table layout of said restaurant during dining service.

Consistent with the principles of the present invention, some embodiments may manage a reservation yield of a hotel or other lodging establishment in a manner that accounts for and utilizes the option to dynamically modify the room characteristics or otherwise reconfigure said hotel or lodging establishment.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention. All documents mentioned herein are hereby incorporated in their entirety by reference.

### BRIEF DESCRIPTION OF THE FIGURES

FIG. 1 is a block diagram of a networked computer system incorporating yield management of dynamically configurable resources consistent with the principles of the invention.

FIG. 2 is a block diagram illustrating the principal components and flow of information there between in a database management system of FIG. 1.

FIG. 3 illustrates the computational logic of a yield management system to estimate whether a restaurant can and ought to accept a single reservation request.

FIG. 4 illustrates examples of inputs and an output of the yield management calculation procedures.

FIG. 5 illustrates an example spreadsheet format for defining restaurant table configurations.

FIG. 6 illustrates an example graphical user interface (GUI) for defining restaurant table configurations.

FIG. 7 is a flowchart for processing a single table reservation request under an exemplary model of use.

FIG. 8 is a Gantt chart summarizing a seating plan of a single dining service.

### DESCRIPTION OF THE PREFERRED EMBODIMENTS

Embodiments consistent with the invention manage reservation yield in a manner that accounts for and utilizes the option to dynamically reconfigure resources. For instance, some embodiments consistent with the principles of the present invention apply yield management (also referred to as “revenue management”) to the reservation acceptance process of a restaurant whose table layout can be dynamically reconfigured. Similarly, yield management may be applied in the context of hotels and/or other lodging establishments whose room layouts can be dynamically reconfigured.

Referring to the restaurant context, via the principles of the present invention, yield management objectives and table configurability objectives may be simultaneously addressed. The embodiments disclosed herein may identify and selectively accept relatively attractive table reservation requests in a manner that recognizes and exploits the possibility of reconfiguring the table layout. For example, both table assignments and the table configuration may “float” or remain flexible until the end of the reservation process, at which time the system may determine a final table layout and assign a specific table to each accepted reservation request. Those of ordinary skill in the art will appreciate that by doing so, greater utilization of limited restaurant table capacity and, in turn, greater revenue without greater fixed costs may be achieved, especially vis-à-vis systems that apply only yield management without accounting for configurability or that account for configurability without managing yield.

Although the description focuses on procedures to determine whether to accept or reject a single pending table reservation request, sequential and parallel application of these procedures may readily extend the description to a reservation system for multiple dining services or meals and multiple restaurants. Furthermore, those of ordinary skill in the art will appreciate that table layout and/or room layout may be, for example, the complete table layout, a partial table layout, etc. Thus, configuring the table layout and/or room layout may be configuring all the tables, a few tables, etc.

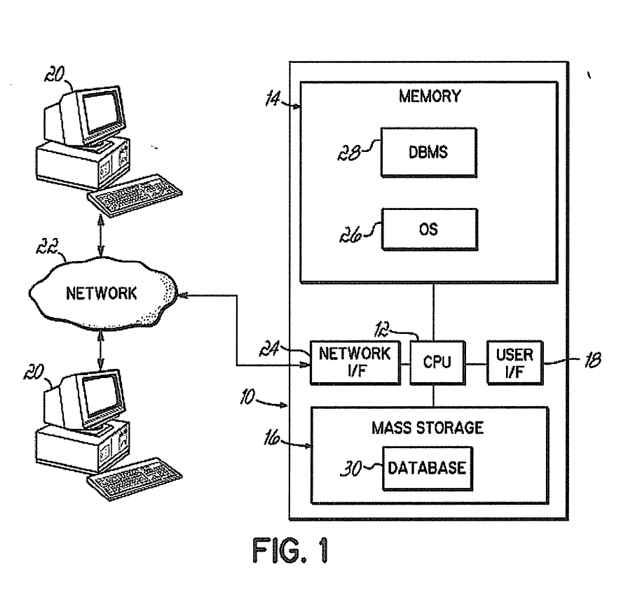

Turning now to the Drawings, wherein like numbers denote like pants throughout the several views, FIG. 1 illustrates an exemplary hardware and software environment for an apparatus 10 suitable for implementing yield management of dynamically configurable resources consistent with the invention. For the purposes of the invention, apparatus 10 may represent practically any type of computer, computer system or other programmable electronic device, including a client computer, a server computer, a portable computer, a handheld computer, an embedded controller, etc. Moreover, apparatus 10 may be implemented using one or more networked computers, e.g., in a cluster or other distributed computing system. Apparatus 10 will hereinafter also be referred to as a “computer,” although it should be appreciated that the term “apparatus” may also include other suitable programmable electronic devices consistent with the invention.

Computer 10 typically includes a central processing unit (CPU) 12 including one or more microprocessors coupled to a memory 14, which may represent the random access memory (RAM) devices comprising the main storage of computer 10, as well as any supplemental levels of memory, e.g., cache memories, non-volatile or backup memories (e.g., programmable or flash memories), read-only memories, etc. In addition, memory 14 may be considered to include memory storage physically located elsewhere in computer 10, e.g., any cache memory in a processor in CPU 12, as well as any storage capacity used as a virtual memory, e.g., as stored on a mass storage device 16 or on another computer coupled to computer 10.

Computer 10 also typically receives a number of inputs and outputs for communicating information externally. For interface with a user or operator, computer 10 typically includes a user interface 18 incorporating one or more user input devices (e.g., a keyboard, a mouse, a trackball, a joystick, a touchpad, and/or a microphone, among others) and a display (e.g., a CRT monitor, an LCD display panel, and/or a speaker, among others). Otherwise, user input may be received via another computer or terminal, e.g., via a client or single-user computer 20 coupled to computer 10 over a network 22. This latter implementation may be desirable where computer 10 is implemented as a server or other form of multi-user computer. However, it should be appreciated that computer 10 may also be implemented as a standalone workstation, desktop, or other single-user computer in some embodiments.

For non-volatile storage, computer 10 typically includes one or more mass storage devices 16, e.g., a floppy or other removable disk drive, a hard disk drive, a direct access storage device (DASD), an optical drive (e.g., a CD drive, a DVD drive, etc.), and/or a tape drive, among others. Furthermore, computer 10 may also include an interface 24 with one or more networks 22 (e.g., a LAN, a WAN, a wireless network, and/or the Internet, among others) to permit the communication of information with other computers and electronic devices. It should be appreciated that computer 10 typically includes suitable analog and/or digital interfaces between CPU 12 and each of components 14, 16, 18, and 24 as is well known in the art.

Computer 10 operates wider the control of an operating system 26, and executes or otherwise relies upon various computer software applications, components, programs, objects, modules, data structures, etc. For example, a database management system (DBMS) 28 may be resident in memory 14 to access a database 30 resident in mass storage 16. Moreover, various applications, components, programs, objects, modules, etc. may also execute on one or more processors in another computer coupled to computer 10 via a network, e.g., in a distributed or client-server computing environment, whereby the processing required to implement the functions of a computer program may be allocated to multiple computers over a network.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable signal bearing media used to actually carry out the distribution. Examples of computer readable signal bearing media include but are not limited to recordable type media such as volatile and non-volatile memory devices, floppy and other removable disks, hard disk drives, magnetic tape, optical disks (e.g., CD-ROMs, DVDs, etc.), among others, and transmission type media such as digital and analog communication links.

In addition, various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to any specific organization and allocation of program functionality described herein.

Those skilled in the art will recognize that the exemplary environment illustrated in FIG. 1 is not intended to limit the present invention. Indeed, those skilled in the art will recognize that other alternative hardware and/or software environments may be used without departing from the scope of the invention.

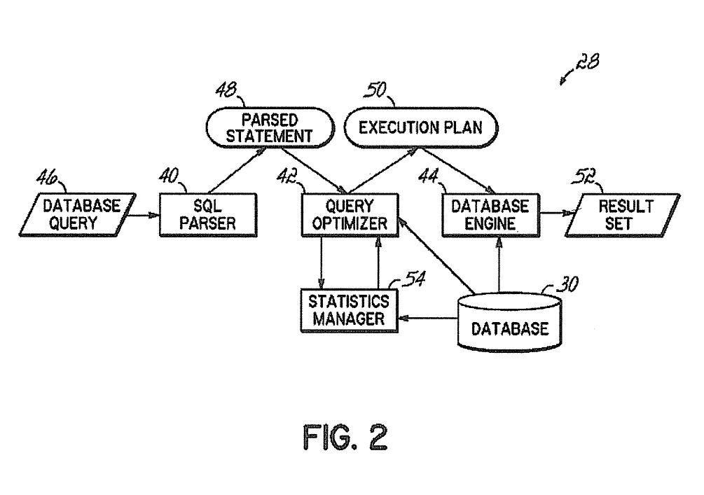

FIG. 2 next illustrates in greater detail the principal components in one implementation of DBMS 28. The principal components of DBMS 28 that are generally relevant to query execution are a Structured Query Language (SQL) parser 40, query optimizer 42 and database engine 44. SQL parser 40 receives from a user (or more typically, an application executed by that user) a database query 46, which in the illustrated embodiment, is provided in the form of an SQL statement. SQL parser 40 then generates a parsed statement 48 therefrom, which is passed to optimizer 42 for query optimization. As a result of query optimization, an execution or access plan 50 is generated. Once generated, the execution plan is forwarded to database engine 44 for execution of the database query on the information in database 30. The result of the execution of the database query is typically stored in a result set, as represented at block 52.

To facilitate the optimization of queries, DBMS 28 may also include a statistics manager 54. Statistics manager 54 may be used to gather, create, and analyze statistical information used by the query optimizer 42 to select an access plan. Those of ordinary skill in the art will also recognize that the exemplary implementation of DBMS 28 illustrated in FIG. 2 is not intended to limit the present invention. Indeed, those skilled in the art will recognize that other alternative hardware and/or software environments may be used without departing from the scope of the invention.

The Yield Management System

In the context of the invention, the yield management systems may combine a computational engine such as CPU 12 to process reservation requests, a database such as database 30, and terminals such as computers 22. The database may store candidate restaurant table configurations, dining hours, lists of accepted reservations, and data used to forecast reservation demand, and perhaps other information. Terminals may be used to enter reservation requests, to receive computational results or outcomes, and to access the database.

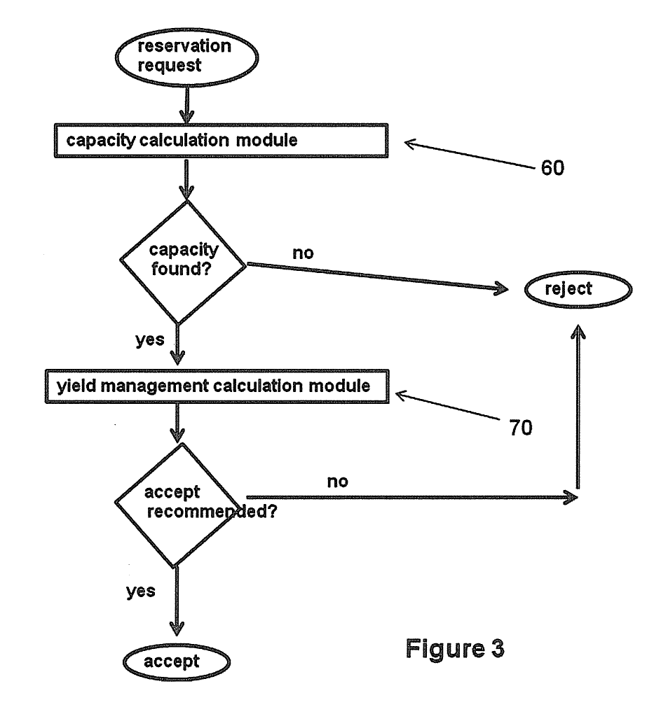

The flowchart FIG. 3 illustrates an exemplary routine depicting a computational sequence by which the system may process a single reservation request, defined by at least a proposed arrival time and group or party size. The system may have two main computational modules, a capacity calculation module 60 to determine or estimate whether the restaurant has table capacity sufficient to accept a request, and a policy module (yield management calculation module) 70 to determine or estimate whether it ought to accept a request for which sufficient capacity exists. Upon receiving a reservation request, the system may first send it to the capacity calculation module 60. If sufficient capacity is not found, the request is directly denied. Otherwise, the request is forwarded to the policy module 70, which utilizes yield management calculations to estimate whether the restaurant ought to accept the request. A request is not necessarily assigned a specific table upon acceptance; rather, table assignments and the table configuration may remain flexible or “float” throughout the reservation process. Methods to perform the calculations of capacity module 60 exist in prior art. For example, mathematical and logical constraints can describe the seating capacity of a restaurant whose tables may be reconfigured, and constraint programming solution procedures can determine or at least estimate whether the restaurant has capacity sufficient to accept a set of table reservation requests.

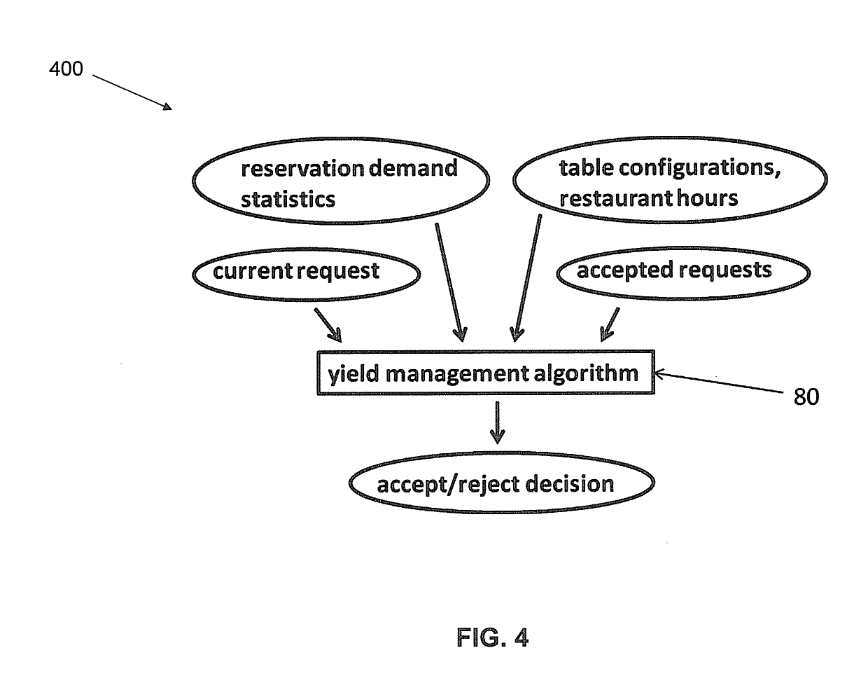

Next, FIG. 4 illustrates an exemplary processing function of yield management procedures embedded in the policy module 70 of FIG. 3. The procedures, including but not limited to the yield management algorithm as described herein, 80 may output a recommendation of whether to accept or reject a pending request based on inputs including basic restaurant information such as possible table configurations and hours of operation, information necessary to forecast future demand for reservation requests, the current or pending reservation request, and/or a list of reservation requests already accepted by the requested restaurant for the requested dining service. At least one other input, not listed, may be utilized. Indeed, while certain inputs will be specified herein, the principles of the present invention are not limited to the exact inputs discussed.

Dynamic Programming Formulation of Yield Management

The yield management problem of whether to accept a table reservation request may be formulated, in one embodiment, as a discrete time dynamic program where the control or decision space at each time consists of just two actions—accept and reject. As such, the reservation process before the dining service in question may be discretized into T time periods and the meal or dining service itself into M time slots. For clarity, the former units of time are referred to as periods and the latter as slots. The restaurant receives a reservation request in each period k<T, though the request may be for a party of size 0 and so serve as only a computational placeholder. Inputs may include potentially period dependent probability distributions for the requested arrival slot and group size, as well as a deterministic number of slots to allow or block off for an accepted reservation request of each potential group size. The presentation will mostly assume a constant meal duration or number of slots to block off, though the general solution approach can accommodate meal durations dependent on group size. Additional inputs may include any number of candidate table configurations, each defined as a set of individual tables. Associated with each table is a seat capacity. Each table may correspond to a particular type or size of table that may be placed at a specific location on the restaurant floor. Those of ordinary skill in the art will appreciate that the system should account for individual tables, as opposed to, say, just counts of table sizes, to ensure the continuity condition that an accepted reservation request be assigned a single table across all required slots. Randomness arises from the uncertainty of future reservation requests.

The restaurant state at time period k may be summarized by the vector (nₖ,\vec{s}ₖ,\vec{t}ₖ,s _{k̅},t _{k̅}). The first three components define already accepted reservation requests, and the latter two describe the pending or current request received in period k. The integer nₖ is the number of requests accepted over periods 1 to k−1, and \vec{s}ₖ is a vector of length nₖ of the corresponding group or party sizes in units of people. The vector \vec{t}ₖ is also of length nₖ and corresponds to the requested arrival time slots of accepted requests. Analogously, the pair s _{k̅},t _{k̅} defines the size and requested arrival slot of the pending reservation request. As noted above, the available control or decision at each period is whether to accept or reject the pending request. So, the system dynamics are as follows.

(nₖ,\vec{s}ₖ,\vec{t}ₖ,s _{k̅},t _{k̅})→(nₖ+1,\vec{s}ₖ∪s _{k̅},\vec{t}ₖ∪t _{k̅},s _{k̅+1},t _{k̅+1}), if the request is accepted, where the operator ∪ appends the following scalar to the preceding vector, and
(nₖ,\vec{s}ₖ,\vec{t}ₖ,s _{k̅},t _{k̅})→(nₖ,\vec{s}ₖ,\vec{t}ₖ,s _{k̅+1},t _{k̅+1}),
if the request is rejected. The system may accept the pending request only if the restaurant has table capacity sufficient to accommodate the pending request as well as all previously accepted requests. In particular, the system may specify a table configuration for each of the M time slots, and it can accept if there exists a configuration sequence such that the pending request and each previously accepted request may be assigned a single sufficiently large table present in each configuration specified for the time window of slots required by the reservation request, without assigning any table to more than one request in any slot.

Though the general approach described here accommodates other objectives, the objective of focus is maximization of the expected cover count or number of seats reserved:

$$E [ {\sum }_{i = 1}^{{n}_{T}} {s}_{T , i} ] ,$$

where the operator E denotes expectation, and in this case is with respect to the unknown table reservation requests, and s_{T,i} denotes the ith component of the vector \vec{s}_{T}. If the number of slots blocked off for an accepted reservation request is constants this objective is directly proportional to expected seat utilization. Let Jₖ(nₖ,\vec{s}ₖ,\vec{t}ₖ,s _{k̅},t _{k̅}) denote the optimal expected number of seats reserved over periods k to T, given the input period k state. The Jₖ(•) values are referred to as the period k seats-to-go function. The dynamic programming recursion is as follows.

$$\begin{matrix}{J}_{T} ( {n}_{T} , {\vec{s}}_{T} , {\vec{t}}_{T} ) = 0 , & ( 1 a ) \\ {J}_{k} ( {n}_{k} , {\vec{s}}_{k} , {\vec{t}}_{k} , {s}_{k}^{*} , {t}_{k}^{*} ) = \{ \begin{matrix}{EJ}_{k + 1} ( {n}_{k} , {\vec{s}}_{k} , {\vec{t}}_{k} , {s}_{k + 1}^{*} , {t}_{k + 1}^{*} ) , & \begin{matrix}if restaurant cannot accept \\ the period k request\end{matrix} \\ max \{ {s}_{k}^{*} + \begin{matrix}{EJ}_{k + 1} ( \begin{matrix}{n}_{k} + 1 , {\vec{s}}_{k} , ⋃ {s}_{k}^{*} , \\ {\vec{t}}_{k} ⋃ {t}_{k}^{*} , {s}_{k + 1}^{*} , {t}_{k + 1}^{*}\end{matrix} ) , \\ {EJ}_{k + 1} ( {n}_{k} , {\vec{s}}_{k} , {\vec{t}}_{k} , {s}_{k + 1}^{*} , {t}_{k + 1}^{*} )\end{matrix} \} , & ow ,\end{matrix} \\ k < T & ( 1 b )\end{matrix}$$

where the expectations are taken over the probability distributions of the unknown reservation request of period k+1. The upper line of equation (1b) corresponds to the necessary rejection of the period k request if restaurant capacity is insufficient to accept the request. The first argument of the max{•} expression corresponds to accepting the pending period k request and the latter to rejecting it. So, the solution to the dynamic program may be a threshold policy in which a request is accepted if its party size exceeds the reduction in expected future seatings due to accepting the request. That is, the period k request is accepted if restaurant capacity is sufficient to accept the request, and the following inequality holds.

s _{k̅}≧EJₖ₊₁(nₖ,\vec{s}ₖ,\vec{t}ₖ,s _{k̅+1},t _{k̅+1})−EJₖ₊₁(nₖ+1,\vec{s}ₖ∪s _{k̅},\vec{t}ₖ∪t _{k̅},s _{k̅+1},t _{k̅+1}) (2)

Approximate Dynamic Programming Solution Approach

While the above recursion is amenable to computer implementation, those of ordinary skill in the art will appreciate that exact solution may be computationally tractable for only small restaurants. In particular, the state space may grow very quickly with restaurant size, and the formulation may exhibit the so-called curse of dimensionality of dynamic programming methods. As such, the combinatorial nature of the state space may render impractically burdensome the memory or solution time required to evaluate the seats-to-go functions Jₖ as called for by the dynamic programming recursion.

To achieve more practical computation times and reduce memory requirements, disclosed hereinbelow is an Approximate Dynamic Programming (ADP) approach based on Monte Carlo simulation and approximation of the seats-to-go functions. Rather than calculating and storing seats-to-go values prior to the reservation process, the ADP approach may approximate in real-time the acceptance threshold (2) of a reservation request that the restaurant can accept, as determined by capacity module 60. To estimate the seats-to-go values Jₖ of the threshold condition (2), the approach may employ a heuristic procedure to estimate a seats-to-go value conditional on a given stream or realization of future reservation requests. In turn, the approach can estimate unconditional seats-to-go values Jₖ through Monte Carlo simulation by iteratively simulating a realization of future reservation requests and calling the heuristic procedure, and then calculating sample means over the iterations. The output means estimate seats-to-go values and may be used in place of the exact Jₖ values of the threshold condition (2). A reservation request satisfying the resulting approximate threshold condition is recommended for acceptance; otherwise, rejection is recommended.

Estimating the Seats-to-Go Conditional on Given Reservation Requests

A heuristic procedure to estimate the seats-to-go value of a restaurant state conditional on a given realization of future reservation requests follows. The heuristic is one of a family of procedures that may be referred to as multi-pass heuristics. The ADP approach could use any one of the multi-pass heuristics; indeed, the approach may be amenable to many different heuristic procedures. While the Jₖ value for a given restaurant state indicates an expected or average seat count calculated over all possible realizations of future reservation requests, the heuristic specified here estimates the future seats reserved from a single stream or realization of such future requests. As indicated above, the ADP approach may estimate the full expectation by iteratively simulating a realization of future requests and calling the heuristic, and then calculating a sample mean over the iterations. Before outlining the heuristic itself, several underlying assumptions and definitions are described.

A set of potentially strong approximations permits the heuristic to streamline calculations. First, it assumes that future requests will become known en masse in one period, rather than one per period. Additionally, it ignores the possibility of accommodating future requests by reassigning previously accepted requests from tentatively assigned tables to other tables. More specifically, upon determining that a restaurant can accept a reservation request, the capacity calculation module 60 may output tentative table assignments for the pending request and all accepted requests. Though such assignments float or remain flexible, the heuristic described here assumes they remain fixed. Those of ordinary skill in the art will recognize that, as a consequence, output of the heuristic depends on the tentative table assignments, as well as the restaurant state and the simulated realization of future reservation demand. Given these assumptions, the heuristic estimates the maximum seats the restaurant can reserve from a given realization of future requests by making two passes through the set of future requests, considering in turn each request on each pass. On the first pass, the heuristic effectively accepts (only “effectively” because the heuristic estimates the number of seats that could be reserved in the future; it accepts no requests) requests that exactly fit (in a sense described below) a specific table, and on the second pass it effectively accepts any reservation the restaurant can accept. As for accepted requests, the heuristic does not consider reassigning effectively accepted requests from one table to another. Despite the potential strength of these approximations, recall that the ultimate aim of the heuristic is to estimate the seat threshold value of (2), which is the difference between the Jₖ values given rejection and given acceptance. So, impacts of the approximations may cancel to the extent that they equally affect both terms of the difference. The multi-pass heuristics follow this general procedure of repeatedly considering in turn each request for effective acceptance and loosening the acceptance criteria.

The multi-pass heuristics may involve “open configurations” and “open tables” for each time slot, as well as a notion of whether a table and a reservation request are an “exact fit”. Those of ordinary skill in the art will observe that these concepts relate to the assumption of fixed tentative table assignments and are less relevant under floating assignments. A configuration or table that is not open is “closed”. A table configuration of the restaurant may be considered to be open at time slot m if it includes all tables to which requests (both accepted requests and simulated future requests effectively accepted by the heuristic itself) have been assigned for slot m. A configuration closed in time slot m cannot accommodate the requests requiring table capacity in slot m. So, those of ordinary skill in the art will appreciate that each slot should have at least one open configuration. A table is open at slot m if it is in some open configuration of slot m and has not yet been assigned a reservation request (again, either an accepted request or an effectively accepted future request) for slot m. A table and a reservation request are an exact fit if the party or group size of the request exactly equals the seat capacity of the table, the table is open in each slot required by the request, and assigning the table to the request does not reduce the potential turn count of the table. The potential turn count of a table is the maximum number of requests to which it might be assigned over the dining service, given and including those requests to which it has already been assigned. Suppose, for example, that a dining service consists of eight time slots and each reservation request covers four slots. A table open for all eight time slots has a potential turn count of two. Assigning a reservation to slots 1-4 does not reduce the count, but assigning to slots 2-5 decreases the count to one.

The multi-pass heuristics may also entail the notion of whether a table is “available” at a certain time slot. Recall that the capacity calculation module 60 of the reservation acceptance process may specify a sequence of table configurations over the M time slots of the dining service, and that each time slot maintains at least one open table configuration. If all possible sequences of table configurations are initially feasible (that is, prior to accepting any reservation requests) then an open configuration in each slot may imply existence of a feasible configuration sequence across the M slots of the dining service. However, if planned transitions between certain configurations are forbidden (perhaps because the transition is deemed too radical to undertake in the middle of service), an open configuration in each slot does not imply a feasible configuration sequence. A table is available in time slot m if it is open during slot m and its assignment to a reservation request during slot m would leave a feasible configuration sequence. A closed table is not available, but an open table is not necessarily available.

A multi-pass heuristic maintains the open status of each configuration and each table in each time slot. Tentative or current table assignments of previously accepted reservation requests, as well as a simulated realization of future reservation requests, are input to the heuristic. The heuristic initializes the open status of each configuration and each table based on the input table assignments, and, as it considers the input future reservation requests, the heuristic maintains the statuses and ensures a feasible configuration sequence. Upon effectively assigning a future request to a table, the heuristic closes the table over the required time slots. Closure of the table would trigger closure over those time slots of any open configurations that do not include the table, which in turn could trigger closure of open tables in such configurations again over the time slots required by the just assigned future request. Before effectively assigning a request to a table, the heuristic ensures availability of the table in each of the required slots. Availability may be verified by first determining the table and configuration closures assignment would entail, and then determining whether a feasible configuration sequence across all time slots would remain. The latter determination may be performed through a breadth first search on a graph with an origin node, a destination node, a node for each (configuration, time slot) combination, and arcs determined by allowed configuration-configuration transitions.

The following pseudocode may specify the aforementioned two-pass heuristic. On a first pass through the future requests, the algorithm considers in turn each simulated future request, and for each such request, considers each table until an available exact fit is found. On a second pass, the algorithm considers in turn each unassigned future request but assigns the request to the first available table of sufficient size that it finds.

function calc_seats_to_go(tent_assignments, fut_requests)
{
Initialize table and configuration open statuses per tent_assignments;
set seats_to_go = 0;
/* first pass */
for r = 1 to num_fut_request

{
for j = 1 to num_table

{
if (table j is available in each slot requested by
fut_request(r) and

(table j and fut_request(r) fit exactly) then

{
assign table j to fut_request(r);
update table and configuration open statuses;
set j = num_table;
seats_to_go = seats_to_go + size(r);
}

}

} /* nextr */

/* second pass */
for r = 1 to num_fut_request

{
for j = 1 to num_table

{
if (fut_request(r) remains unassigned) and

(table j is available in each slot requested by
fut_request(r)) and
(capacity(j) >= size(r)) then

{
assign table j to fut_request(r);
update table and configuration open statuses;
set j = num_table;
seats_to_go = seats_to_go + size(r);
}

}

} /* nextr */

return(seats_to_go);
}

The input arguments tent_requests and fut_requests specify tentative table assignments of accepted reservation requests and a set of (simulated) future requests, respectively. The loop index limit num_fut_request is the number of such future reservation requests, and the index limit num_table is the number of tables, across all configurations. The parameter capacity(j) denotes the seat capacity of table j, and size(r) denotes the number of people in future reservation request r.

### Illustrative Example

The following example illustrates calculations of the two-pass heuristic. Consider a hypothetical ten seat restaurant with two possible table configurations. Configuration A consists of a table for four and a table for six, tables b and d, respectively. Configuration B consists of a table for two and two tables for four, tables a, b, and c. A planned configuration sequence is considered feasible if the configuration of each time slot has table capacity to accommodate the requests requiring that slot, and each accepted request can be assigned a single table over all of its requested slots. So, no configuration-configuration transitions are forbidden a priori, and, consequently, open tables are available. Dining service consists of six time slots, and two slots are blocked off for each accepted reservation request. The restaurant has already accepted a request I for a group of two for slots 2 and 3, as well as a request II for a group of four for slots 5 and 6. Request I is tentatively assigned to table a and request II to table b. Assume a simulator has generated as a possible realization of future demand the four future reservation requests summarized in Table 1.

TABLE 1
Simulated reservation requests.

| request | group size | slots |
|---|---|---|
| i | 4 | 4, 5 |
| ii | 2 | 2, 3 |
| iii | 6 | 1, 2 |
| iv | 4 | 3, 4 |

The table assignments of the accepted reservations imply that configuration A is closed in time slots 2 and 3 and open in all other slots, and that configuration B remains open in all six slots. Consequently, tables a and d are closed in slots 2 and 3 and open in other slots, table b is closed in slots 5 and 6 and remains open in slots 1-4, and table c remains open in all six slots. Table 2 displays restaurant table statuses prior to the first pass. An open box indicates an open table, and an ‘x’ indicates a closed table.

TABLE 2
Initial table statuses.

| slot/table | a | b | c | d |
|---|---|---|---|---|
| 1 | | | | |
| 2 | x | | | x |
| 3 | x | | | x |
| 4 | | | | |
| 5 | | x | | |
| 6 | | x | | |

The first pass effectively accepts only request iv. Tables c and d are available and of sufficient size for request i, but neither is an exact fit. Request i would reduce the potential turn count of table c, and the seat capacity of table d exceeds the size of request i. Similarly, no table exactly fits request ii or request iii. Request iv is effectively accepted to table b, whose potential turn count remains three. This assignment closes table b in slots 3 and 4 but does not imply closure of any configurations or other tables. Table 3 summarizes restaurant table statuses after the first pass.

TABLE 3
Table statuses after first pass.

| slot/table | a | b | c | d |
|---|---|---|---|---|
| 1 | | | | |
| 2 | x | | | x |
| 3 | x | x | | x |
| 4 | | x | | |
| 5 | | x | | |
| 6 | | x | | |

The second pass accepts requests i and ii but rejects request iii. Table a is too small for request i, and table b is unavailable, but request i is effectively accepted to table c. This assignment closes table c for slots 4 and 5, which, in turn, closes configuration A as well as table d for slots 4 and 5. Request ii is also effectively accepted to table c, and the assignment closes just table c for slots 2 and 3. No available table has enough seats to accommodate request iii, so it is rejected. Table 4 summarizes restaurant table statuses after the second pass.

TABLE 4
Table statuses after second pass.

| slot/table | a | b | c | d |
|---|---|---|---|---|
| 1 | | | | |
| 2 | x | | x | x |
| 3 | x | x | x | x |
| 4 | | x | x | x |
| 5 | | x | x | x |
| 6 | | x | | |

Since the algorithm effectively accepts requests i, ii, and iv, it returns a value of 10. Additional iterations of simulating future demand and running the two-pass heuristic could refine the estimated seats-to-go value for a dynamic programming state of accepted requests I and II.

### Example Test

As an example test, consider a hypothetical restaurant of twenty seats that can adopt any of the eight table configurations consisting of tables of two, three, four, five, or six seats, and specified in Table 5 (below). Table 5 may be read horizontally. So, for example, configuration B includes three tables with two seats, two tables with four seats, and one table with six seats. As for the above illustrative example, a planned configuration sequence is considered feasible if the configuration of each time slot has table capacity to accommodate the requests requiring that slot, and each accepted request may be assigned a single table. The dining service consists of ten time slots, and the restaurant blocks off three slots for each accepted reservation request. Consequently, slot 8 is the last arrival slot for which a request can be accepted, as the restaurant would assign such a request a table for times slots 8, 9, and 10. Suppose the reservation acceptance process consists of 100, 150, or 200 periods, each of which receives a nonzero reservation request with probability 0.2. Finally, suppose uniform distribution of nonzero requests over the five possible group sizes and the eight possible arrival slots.

TABLE 5
Table size counts of candidate table configurations.

| | table size | | | | |
|---|---|---|---|---|---|
| configuration | 2 | 3 | 4 | 5 | 6 |
| A | 1 | 1 | 1 | 1 | 1 |
| B | 3 | 0 | 2 | 0 | 1 |
| C | 2 | 0 | 1 | 0 | 2 |
| D | 2 | 1 | 2 | 1 | 0 |
| E | 2 | 2 | 1 | 0 | 1 |
| F | 3 | 2 | 2 | 0 | 0 |
| G | 0 | 1 | 0 | 1 | 2 |
| H | 0 | 0 | 1 | 2 | 1 |

For each of thirty trials, ten for each of the three reservation process length values T, reservation request demand per the assumed probability distributions was generated, and five different reservation systems were simulated. The first two systems apply rules-of-thumb that consider only configuration A and do not employ yield management. The first accepts a request if it can be directly (that is, without reassigning any previously accepted reservations) assigned a table of its exact size. The second accepts a request if it can be directly assigned any sufficiently large table, and, if so, assigns it to a smallest such table. The third system considers all eight configurations and accepts any request the restaurant can accept, as determined by the configurability capacity module 60. The fourth system considers only configuration A but accepts reservation requests per yield management. The final system employs both configurability and yield management. The average seat utilizations (Recall that reserved seat utilization and cover count are directly proportional if the number of slots blocked off for an accepted request is constant.) of the table schedules output by the five systems were, respectively, 62.8%, 62.1%, 67.0%, 69.1%, and 72.0%. Thus, configurability may achieve an average utilization around 4.5 percentage points higher than the rules-of-thumb, and yield management may increase utilization around 6.5 percentage points. The system equipped with configurability and yield management may average 5.0 percentage points higher than that with configurability alone and 2.9 percentage points higher than that with yield management alone.

Greater Computational Efficiency

Additional approximations may further streamline calculations without unacceptably degrading accuracy. First, relatively simple rules-of-thumb, rather than more formal yield management calculations, may be used to accept or reject certain reservation requests. For example, given the tentative table assignments of already accepted requests and a tentative configuration sequence, a request that may be directly assigned to or exactly fits (in the senses described above) some table, may be deemed attractive prima facie and so accepted without further calculation.

Computational efficiency may also follow from disaggregation. More specifically, it may be possible to partition the floor space of a restaurant into, say, rooms that can be independently reconfigured, and then treat each room much like a separate restaurant. Under disaggregated calculations, each room might effectively have its own capacity module 60 and yield management module 70, and each table reservation request received by the restaurant might be forwarded in turn to the modules of each room, until some room accepts the request or all reject it. Disaggregation would likely complicate generation of any reservation demand forecasts necessary for yield management calculations, since a forecast for each room rather than simply the restaurant as a whole may be required. Such complications could be addressed thorough numerous methods. For example, demand to a specific room r may be forecast by filtering from a forecast for demand to the restaurant as a whole requests that might reasonably be accepted by some other room. Such filtered requests might include any forecast request that may be directly assigned to or exactly fits some table of a room that accepts or rejects requests prior to room r in the room progression of the disaggregated approach.

Models of Use The disclosed invention may be used in numerous embodiments. The following examples illustrate exemplary models of use and are not intended to be proscriptive or exhaustive.

In a first model of use, the invention may provide the basis of a standalone software package employed by a single restaurant. Prior to deployment, restaurant management or a software vendor may implement a reservation database, a table configuration database, a forecasting engine, or some other data repository containing data relating to the restaurant and applicable to the reservation process. The reservation database may contain a record of reservations accepted for each dining service over a planning horizon of a length likely set by restaurant management. For example, if restaurant management accepts reservations only for dinner and up to thirty days in advance, the database could include a list or record of reservations accepted for each of the next thirty diluter services. The entry for each reservation could include a group name, a group size, an expected arrival slot, a tentative table assignment, or some other datum. The planing horizon underlying the reservation database could update on a rolling basis. For the example case, each day a new reservation list could be instantiated for the dinner service thirty days hence, and the list for the dining service of the current day could expire.

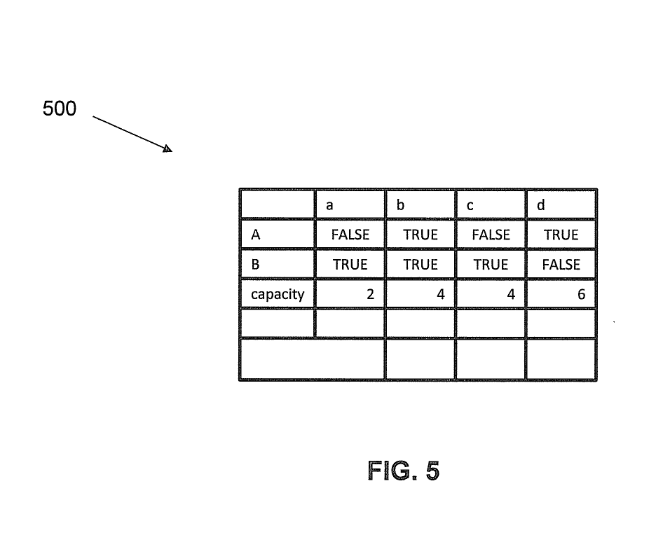

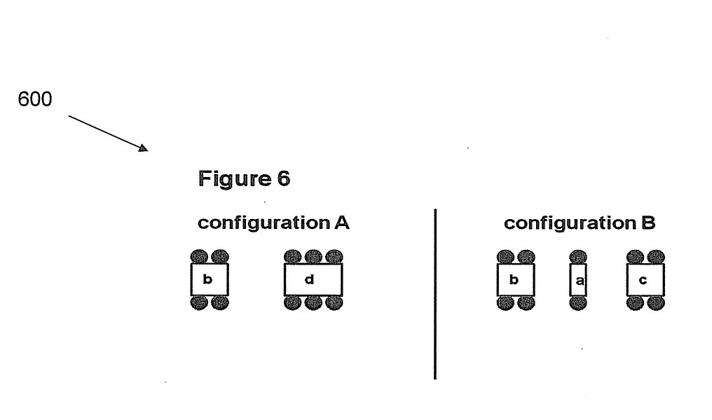

The table configuration database may indicate possible configurations or layouts of the restaurant's table capacity. Each configuration could be defined by a list of indices, with each index corresponding to a specific type of table positioned at a specific location on the dining floor. A seating capacity could be associated with each table index. The configuration database could be populated by directly entering the relevant indices in a formatted spreadsheet to be read by the reservation software. A graphical user interface (GUI) may also be associated with the software and used for populating a configuration database, as well as performing other data entry and data visualization tasks. Such an interface might enable a user to create images of table configurations and then automate translation of the images into the relevant numerical representations. FIG. 5 illustrates a possible spreadsheet configuration definition format 500. The restaurant in question (as in the above Illustrative Example illustrating the two-pass heuristic) has four tables, a, b, c, and d, and two configurations, A and B. Table a has two seats; tables b and c have four seats each; and table d has six seats. Tables b and d comprise configuration A, and tables a, b, and c comprise configuration B. Table d is created by joining tables a and c. FIG. 6 illustrates the same table configuration information 600 graphically. Configuration A is shown at left and configuration B at right.

Continuing the example, the forecasting engine could employ one or more statistical models to simulate remaining reservation request demand for any dining service in the planning horizon. For example, as in the above Dynamic Programming Formulation of Yield Management, the forecasting calculations might discretize time remaining until a particular dining service into a number of periods and assume a reservation request is made in each such period with a constant probability. Numerous other models of reservation demand are possible, and forecasting model parameters such as the constant probability of receiving a reservation request could be estimated in numerous ways, including rigorous statistical analysis of historical demand and merely asking restaurant management for reasonable estimates.

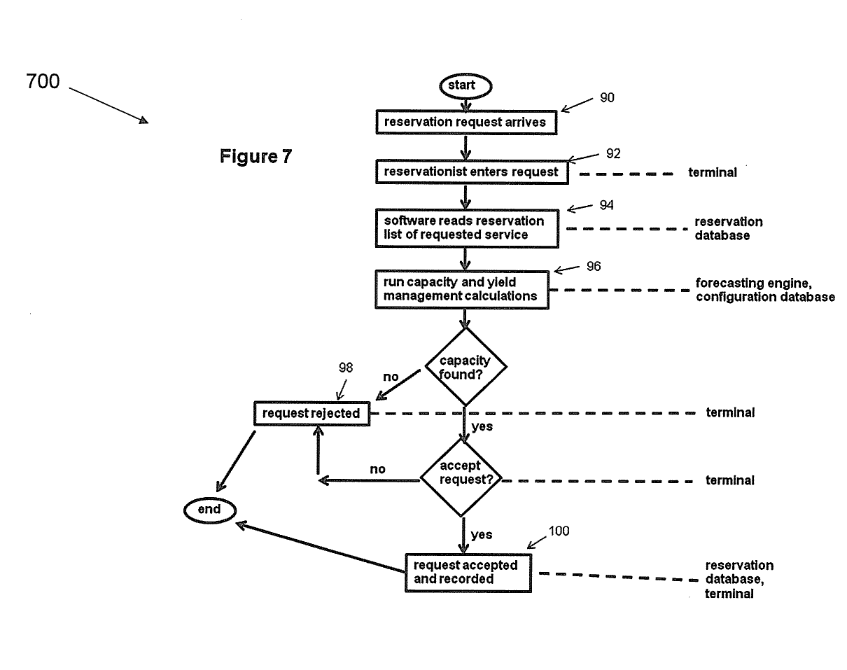

Once deployed, the standalone reservation software may assist restaurant management in determining which reservation requests to accept during the day-to-day reservation acceptance process. FIG. 7 illustrates a possible flow 700 of the process to address a single request. A dashed line connects a step of the process to associated hardware. In step 92, upon receiving a reservation request, either in person or by phone, a reservationist enters at a terminal relevant information including at least group size and the requested arrival time slot. In step 94 the software reads from the reservation database the reservation list of the requested dining service. Utilizing the table configuration database and iteratively calling the forecasting engine, in step 96, the capacity and yield management modules may then estimate and indicate to the reservationist whether the restaurant has the capacity to accept the request, and, if so, whether the yield management calculations recommend acceptance. Given sufficient table capacity, the reservationist may decide whether to override the yield management recommendation. In step 98, the reservationist rejects the request, either because sufficient capacity was not found or because the reservationist has decided to reject the request despite sufficient capacity. The latter case might involve overriding a recommendation of the yield management calculations to accept the request. In step 100, the reservationist accepts the reservation, and the software appends the accepted request to the reservation list of the requested dining service. Future table capacity and yield management calculations for that dining service could reflect the committed seats.

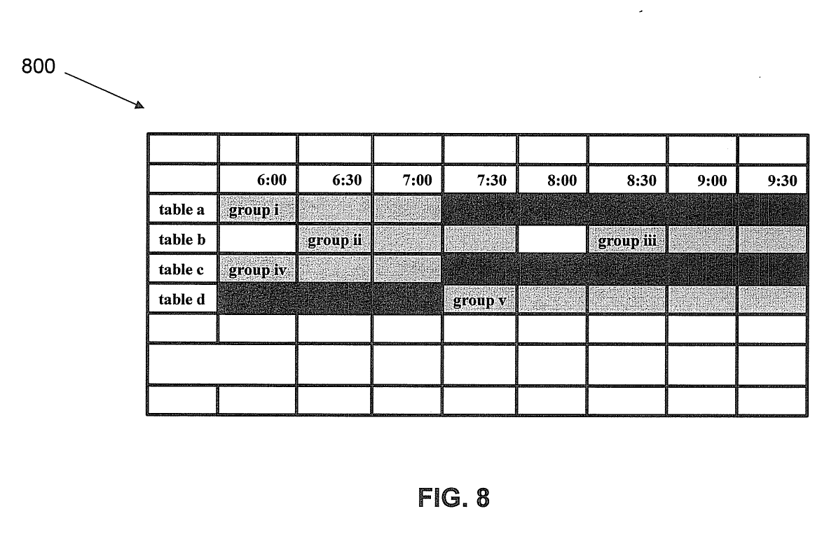

Shortly before commencing service, restaurant management could use the software to generate a corresponding reservation list. The information in a reservation database for the imminent service could be presented in many different formats. One potentially useful format is a Gantt chart with a row for each table and a column for each time slot. FIG. 8 illustrates a Gantt chart 800 for a restaurant with four tables and half-hour slots over a dining service from 6:00-10:00. The second row of the chart indicates that the current seating plan of the reservation system has tentatively assigned two groups to table b. A 6:30 reservation has been accepted for group ii, and the system has allocated an hour and a half for the reservation. Similarly, an 8:30 reservation has been accepted for group iii, and the system has also allocated an hour and a half for this reservation. The current seating plan calls for table b to remain unoccupied from 6:00 to 6:30 and 8:00 to 8:30. The first, third, and fourth rows of the chart indicate assignment of tables a and c from 6:00 to 7:30 and assignment of table d from 7:30 until the end of service. The black boxes indicate absence of the corresponding tables from the dining floor. If table d is created by joining tables a and c (as in, for example, FIGS. 5 and 6), the planned schedule would call for this configuration or layout change upon departure of groups i and iv, and so necessitate the indicated table absences.

The standalone model of use could be extended by connecting the reservation engine to the Internet. This second model of use also employs software dedicated to a single restaurant but would enable remote potential diners to request reservations at any time and to receive real-time responses. Phone and in person reservation requests would be handled as in FIG. 7, but remote requests could be handled by the reservation engine without intervention by restaurant management. Such remote requests could be processed similarly to the flow of FIG. 7. However, in such cases, the potential diner rather than a reservationist would enter reservation information, again including at least a group size and a requested arrival slot. Diners might access the reservation system through numerous devices including a networked personal computer and a cellphone. Also, for such remote requests, accept/reject decisions likely would be made per capacity and yield management calculations. That is, in terms of FIG. 7, steps 98 and 100 would no longer include options to override calculated yield management recommendations.

A third model of use employs the invention within a third party reservation service, likely accessed through the Internet by both restaurant management and potential diners. The architecture of such a system could be diagramed as in FIG. 1, though there would be many terminals, at least one for each restaurant subscribing to the service and perhaps an additional one for each potential diner. In addition to personal computers, diners and perhaps restaurant managers might also access the system through cellphones and other networked devices. The system database would include a forecasting engine, table configuration database, and reservation database for each involved restaurant. Reservation requests, whether in person, by phone, or online, would be entered and processed per the potentially modified flow of FIG. 7 described above for the second model of use. However, information would be sent to and processed by software residing on a central server that might be maintained by the third party.

Variations and Extensions

Those of ordinary skill in the art will appreciate that many variations and extensions consistent with the principles of the present invention may be possible. For example, the described two-pass heuristic is just one of a family of multi-pass heuristics, each defined by a number of progressively less restrictive passes through the simulated realization of reservation requests. Many multi-pass heuristics may be devised by varying the number of passes and acceptance criteria. Furthermore, the ADP approach may accommodate any reasonable heuristic to approximate conditional seats-to-go values. More generally, other approximate dynamic programming strategies may be utilized to reduce the memory requirements and/or computational time of exactly solving the dynamic program, and, in certain situations, exact solution might be practical.

The underlying formulation itself could be readily extended. First, on a more theoretical note, those skilled in the art will recognize that since the ADP approach estimates in real-time the threshold value of (2), the approach applies to a continuous time underlying formulation, as well as the discrete time formulation described herein. Also, while the underlying exact Dynamic Programming Formulation incorporates a specific model of reservation demand, the general solution approach could accommodate numerous demand models; the described approach could employ almost simulation engine capable of generating possible future demand streams of an appropriate format.

The objective maximization of the expected seats reserved or cover count may be different. Alternate objectives may include maximizing expected seat utilization and maximizing expected revenues. Effecting the latter objective could involve associating an expected revenue or spend with each group size. Additionally, although constraints on table capacity, dining continuity (the condition that an accepted reservation be assigned a single table), and configuration transitions have been considered herein, other potentially relevant constraints, including a limit on the number of people and/or covers seated in one slot, may be considered as well. Similarly, the system could incorporate management defined seating rules, such as minimum party sizes at certain tables and a ban or limit on large group sizes at peak hours. Such rules could supplement fundamental yield management calculations.

A more granular model of tables or reservation requests may be accommodated in some embodiments. The above discussion assumed a constant meal duration or number of slots blocked off for each accepted reservation. This constant could readily be customized for each restaurant; meals likely last longer and so more time should be allowed for each reservation at more formal restaurants. Also, as noted above, the general approach can accommodate meal durations that depend on group size; restaurants might allow more time for larger groups. The approach might be further extended to allow group specific meal durations, such that, for example, a restaurant allows more time for diners known to be slow. The above discussion associates with each table a seating capacity. Tables may be more fully described by features including, for example, relative privacy, dining room, view, etc. Reservation requests might then specify or require one or more such features or even an exact table. In turn, yield management calculations could reflect the additional constraints and consequent inflexibility incurred by accepting a highly specific request. That is, even if the restaurant could accommodate such a request, say a request for a specific table for four or a table for four in a particular room, yield management calculations would likely more readily accept a general request for simply four people, all else equal.

Furthermore, the principles of the present invention may also be applied in other settings, in particular hotels and lodging. Though the configurability of a restaurant table layout seems more familiar, configurable hotels may also be possible. Hotel management may dynamically change the characteristics of available rooms by, for example, replacing a king-size bed with two twins. Moreover, the room assignments and/or the room characteristics may remain flexible until an end of a reservation process. At the end of the reservation process, the room characteristic may be determined and/or a specific room assigned to each accepted reservation request.

Various modifications may be made to the illustrated embodiments without departing from the spirit and scope of the invention.

The methods and systems described herein may be deployed in part or in whole t-rough a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the alt. Accordingly, the spirit and scope of the present invention is not to be limited by the foregoing examples, but is to be understood in the broadest sense allowable by law.

All documents referenced herein are hereby incorporated by reference.

1. A computer-implemented method to manage a reservation yield of a restaurant comprising:
receiving a reservation request to be seated in a restaurant, wherein the request is associated with a requested seating constraint;
transferring the reservation request to a restaurant capacity calculation module, wherein the restaurant capacity calculation module is further associated with a data facility including data relating to restaurant capacity and configuration;
performing a calculation within a capacity calculation module to determine if sufficient capacity exists at the restaurant to accommodate the reservation request;
performing a statistical calculation within a yield management calculation module, wherein the statistical calculation includes analysis of alternate physical arrangements of the restaurant's physical infrastructure to select a target physical arrangement in order to optimize a yield criterion;
selecting the target physical arrangement; and
recording a reservation to accommodate the reservation request within the target physical arrangement.

2. Further comprising the method of claim 1, wherein the performance of the statistical calculation within the yield management calculation module to determine if sufficient capacity exists at the restaurant to accommodate the reservation request includes a calculation to accommodate a prior reservation, in combination with the reservation, within the target physical arrangement.

3. Further comprising the method of claim 1, wherein a physical arrangement of the restaurant is transformed to the target physical arrangement.

4. The method of claim 1, wherein the seating constraint is a requested seating date.

5. The method of claim 1, wherein the seating constraint is a requested seating time.

6. The method of claim 1, wherein the seating constraint is a requested number of persons to be seated at the restaurant.

7. The method of claim 1, wherein the seating constraint is a requested location in the restaurant.

8. The method of claim 7, wherein the requested location in the restaurant is a specified table.

9. The method of claim 1, wherein the seating constraint is a requested seating date and time combination.

10. The method of claim 1, wherein the seating constraint is a combination of a requested seating date, seating time, and a requested number of persons to be seated.

11. The method of claim 1, wherein the seating constraint is a combination of a requested seating date, seating time, a requested number of persons to be seated, and a requested location in the restaurant.

12. The method of claim 1, wherein the data relating to restaurant capacity and configuration includes the total number of tables at the restaurant.

13. The method of claim 1, wherein the data relating to restaurant capacity and configuration includes the total number of tables currently available at the restaurant that have not been reserved.

14. The method of claim 1, wherein the data relating to restaurant capacity and configuration includes the total number of seats at the restaurant.

15. The method of claim 1, wherein the data relating to restaurant capacity and configuration includes the total number of seats currently available at the restaurant that have not been reserved.

16. The method of claim 1, wherein the data relating to restaurant capacity and configuration includes data describing the table types that are present at the restaurant.

17. The method of claim 16, wherein the data describing the table types that are present at the restaurant includes data relating to the number of seats at a table.

18-22. (canceled)

23. The method of claim 1, wherein the yield criterion is a revenue metric.

24-26. (canceled)

27. The method of claim 1, wherein the yield criterion is a measure of the percentage of full capacity seating achieved.

28. The method of claim 1, wherein the yield criterion is optimized by controlling availability of table reservations according to a diner class.

29. The method of claim 28, wherein the diner class is based at least in part on a diner's requested seating time.

30. The method of claim 28, wherein the diner class is based at least in part on a requested number of persons to be seated.

31-36. (canceled)

37. The method of claim 1, wherein the yield management calculation module calculates a statistical forecast of reservation demand.

38. The method of claim 37, wherein the target physical arrangement is selected based at least in part by using a statistical forecast of reservation demand.

39. The method of claim 1, wherein the capacity calculation module employs dynamic programming techniques.

40. The method of claim 1, wherein the yield management calculation module employs dynamic programming techniques.

41. The method of claim 1, wherein the target physical arrangement, based at least in part on a table assignment and a table configuration, remain flexible until an end of a reservation process.

42. The method of claim 1, wherein a table layout is determined at the end of the reservation process and a specific table is assigned to a reservation request.

43. A computer-implemented method to manage a reservation yield of a restaurant comprising:
receiving a reservation request to be seated in a restaurant, wherein the request is associated with a requested seating constraint;
transferring the reservation request to a restaurant capacity calculation module, wherein the restaurant capacity calculation module is further associated with a data facility including data relating to restaurant capacity and configuration;
performing a calculation within a capacity calculation module to determine if sufficient capacity exists at the restaurant to accommodate the reservation request;
performing a statistical calculation within a yield management calculation module, wherein the statistical calculation includes analysis of alternate physical arrangements of the restaurant's physical infrastructure to select a set of possible target physical arrangements;
recording a reservation to accommodate the reservation request within one or more members of the set of target physical arrangements.

44. An apparatus, comprising:
a processor;
a memory; and
program code resident in the memory and configured to be executed by the processor to manage a reservation yield of a restaurant that accounts for and utilizes the option to dynamically reconfigure the table layout of said restaurant during dining service.

45. (canceled)

46. A computer-implemented method to manage a reservation yield of a hotel or other lodging establishment that accounts for and utilizes the option to dynamically modify the room characteristics or otherwise reconfigure said hotel or lodging establishment.

47. The method of claim 46, wherein room assignments and the room characteristics remain flexible until an end of a reservation process, and wherein at the end of the reservation process the room characteristics are determined and a specific room is assigned to each accepted reservation request.

48-49. (canceled)
